(19) United States
(12) Patent Application Publication
(10) Pub. No.: US 2025/0158809 A1
(43) Pub. Date: May 15, 2025

(54) PRIVACY-PRESERVING BIOMETRICS FOR MULTI-FACTOR AUTHENTICATION

(71) Applicant: Visa International Service Association, San Francisco, CA (US)

(72) Inventors: Saikrishna Badrinarayanan, Fremont, CA (US); Sunpreet Singh Arora, Union City, CA (US)

(73) Assignee: Visa International Service Association, San Francisco, CA (US)

(21) Appl. No.: 18/838,520

(22) PCT Filed: Feb. 2, 2023
(86) PCT No.: PCT/US2023/061861

§ 371 Date: Aug. 14, 2024

Related U.S. Application Data
(60) Provisional application No. 63/310,666, filed on Feb. 16, 2022.

(51) Int. Cl. H04L 9/08; H04L 9/00; H04L 9/32; H04W 12/33; H04W 12/63

(52) U.S. Cl. CPC H04L 9/0866; H04L 9/008; H04L 9/3231; H04W 12/33; H04W 12/63

(57) ABSTRACT

A method includes generating a second public key and a second private key of a second public-private key pair, and transmitting the second public key to a first user device, which stores an encrypted biometric template. The encrypted biometric template is a biometric template encrypted with a first public key of a first public-private key pair. The first user device encrypts the encrypted biometric template with the second public key to form a double encrypted biometric template. The method includes receiving the double encrypted biometric template from the first user device, decrypting the double encrypted biometric template using the second private key to obtain the encrypted biometric template, determining a test biometric template and encrypting the test biometric template, comparing the encrypt-test biometric template and the encrypted biometric template to obtain an encrypted biometric match score, and transmitting the encrypted biometric match score to a server computer.

### CROSS-REFERENCES TO RELATED APPLICATIONS

This application is a PCT application which claims priority to U.S. provisional application No. 63/310,666 filed on Feb. 16, 2022, which is herein incorporated by reference in its entirety.

### BACKGROUND

An authentication technique can be used to determine whether a user is authentic. A user device can authenticate a user by requiring that the user provide a biometric sample that matches another biometric sample stored on the user device, before the user device will allow the user to take a particular action.

While such authentication methods are useful, they can be cumbersome when a user has multiple user devices (e.g., a phone, a smart watch, a laptop computer, etc.), or is replacing an older user device with a new user device. If this is the case, then multiple biometric enrollment steps for each user device would be required. It would also be desirable to reduce the number of times that a user needs to enroll a biometric with new user devices. Enrolling a biometric multiple times can be cumbersome and inconvenient.

Embodiments of the disclosure address this problem and other problems individually and collectively.

### SUMMARY

One embodiment of the invention includes a method comprising: generating, by a second user device, a second public key and a second private key of a second public-private key pair; transmitting, by the second user device, the second public key to a first user device, which stores an encrypted biometric template, the encrypted biometric template being a biometric template encrypted with a first public key of a first public-private key pair, wherein the first user device encrypts the encrypted biometric template with the second public key to form a double encrypted biometric template; receiving, by the second user device, the double encrypted biometric template from the first user device; decrypting, by the second user device, the double encrypted biometric template using the second private key to obtain the encrypted biometric template; determining, by the second user device, a test biometric template and encrypting the test biometric template; comparing, by the second user device, the encrypted test biometric template and the encrypted biometric template to obtain an encrypted biometric match score; and transmitting, by the second user device, the encrypted biometric match score to a server computer, wherein the server computer decrypts the encrypted biometric match score to obtain a biometric match score, and allowing the second user device to perform a process if the biometric match score exceed a threshold.

Another embodiment of the invention include a second user device comprising: a processor; a memory comprising a hash index table and an array index table; and a computer readable medium coupled to the process, the computer readable medium comprising code executable by the processor for performing operations comprising: generating a second public key and a second private key of a second public-private key pair; transmitting the second public key to a first user device, which stores an encrypted biometric template, the encrypted biometric template being a biometric template encrypted with a first public key of a first public-private key pair, wherein the first user device encrypts the encrypted biometric template with the second public key to form a double encrypted biometric template; receiving the double encrypted biometric template; decrypting the double encrypted biometric template using the second private key to obtain the encrypted biometric template; determining a test biometric template and encrypting the test biometric template; comparing the encrypted test biometric template and the encrypted biometric template to obtain an encrypted match score; and transmitting the encrypted biometric match score to a server computer, wherein the server computer decrypts the encrypted biometric match score to obtain a biometric match score, and allowing the second user device to perform a process if the biometric match score exceed a threshold.

Another embodiment includes a method comprising: generating, by a server computer, a first public-private key pair comprising a first public key and a first private key; transmitting, by the server computer, the first public key to a first user device, which encrypts a biometric template with the first public key to form an encrypted biometric template, encrypts the encrypted biometric template with a second public key of a second public-private key pair to form a double encrypted biometric template, and transfers the double encrypted biometric template to a second user device, which decrypts the double encrypted biometric template with a second private key of the second public-private key pair to obtain the encrypted biometric template, receives a test biometric template, encrypts the test biometric template using the first public key, and computes an encrypted score using the encrypted biometric template and the encrypted test biometric template; receiving, by the server computer, the encrypted score; decrypting, by the server computer the encrypted score using the first private key to form a biometric match score; determining, by the server computer, if the biometric match score exceeds a threshold; and performing an process on behalf of the second user device if the score exceeds the threshold.

Another embodiment of the invention includes a server computer comprising a processor; and a computer readable medium, the computer readable medium comprising code executable by the processor for performing a method comprising: generating a first public-private key pair comprising a first public key and a first private key; transmitting the first public key to a first user device, which encrypts a biometric template with the first public key to form an encrypted biometric template, encrypts the encrypted biometric template with a second public key of a second public-private key pair to form a double encrypted biometric template, and transfers the double encrypted biometric template to a second user device, which decrypts the double encrypted biometric template with a second private key of the second public-private key pair to obtain the encrypted biometric template, receives a test biometric template, encrypts the test biometric template using the first public key, and computes an encrypted score using the encrypted biometric template and the encrypted test biometric template; receiving the encrypted score; decrypting, by the server computer the encrypted score using the first private key to form a biometric match score; determining, by the server computer, if the biometric match score exceeds a threshold; and performing a process on behalf of the second user device if the score exceeds the threshold.

A better understanding of the nature and advantages of embodiments of the invention may be gained with reference to the following detailed description and accompanying drawings.

### BRIEF DESCRIPTION OF THE DRAWINGS

FIG. 1 shows a swim lane diagram of enrolling a biometric template of a user using a first user device.

FIG. 2 shows a swim lane diagram of a first user device sharing an enrolled biometric template with a second user device.

FIG. 3 shows a swim lane diagram of authenticating a user using a second user device by comparing a biometric template with a test biometric template of a user.

FIG. 4 shows a block diagram of a user device according to an embodiment.

FIG. 5 shows a block diagram of a server computer according to an embodiment.

### DETAILED DESCRIPTION

Prior to discussing embodiments of the disclosure, some terms can be described in further detail.

A “user” may include an individual. In some embodiments, a user may be associated with one or more personal accounts and/or user devices.

A “credential” may be any suitable information that serves as reliable evidence of worth, ownership, identity, or authority. A credential may be a string of numbers, letters, or any other suitable characters that may be present or contained in any object or document that can serve as confirmation.

A “user device” may be any suitable device that is operated by a user. Suitable user devices can be portable and can communicate with external entities such as access devices. Examples of user devices include mobile phones, laptop computers, smartwatches, access cards, smart cards, etc.

A “server computer” may include a computer or cluster of computers that can service the requests of one or more client computers. For example, the server computer can be a large mainframe, a minicomputer cluster, or a group of servers functioning as a unit. In one example, the server computer may be a database server coupled to a web server. The server computer may comprise one or more computational apparatuses and may use any of a variety of computing structures, arrangements, and compilations for servicing the requests such as authentication requests from one or more client computers.

“Authentication” or “authenticating” may be the process of proving or verifying certain information, and/or verifying the identity of the source of that information. For example, a user may provide authentication data that is unique or only known to the user to prove the identity of the user. Examples of different types of authentication data may include biometrics (e.g., fingerprints, palm prints, face images, iris and/or retinal scans, voice prints, gaits, etc.), passcodes, PINs, answers to security questions, cryptographic responses to challenges, human and/or device signatures, etc.

“Biometric data” can include any suitable biological measurements. Examples of biometric data may include retina images, iris images, facial images, fingerprints, handprints, or voice samples.

A “biometric template” can include a digital reference of distinct characteristics that have been extracted from a biometric sample/biometric data. By way of example, a biometric sample may be utilized to extract unique features of the sample which may then be analyzed and converted into a mathematical file that is known as a biometric template. This template may no longer include the original biometric data as captured by the user device.

A “biometric reader” may refer to a device for measuring a biometric. Examples of biometric readers may include fingerprint readers, front-facing cameras, microphones, iris scanners, retinal scanners, and DNA analyzers.

“Homomorphic encryption” can refer to a form of encryption that allows computation on ciphertexts, generating an encrypted result which, when decrypted, matches the result of the operations as if they had been performed on the plaintext. Thus, two encrypted biometric templates may be used to generate an encrypted result, that when decrypted, matches the result of the operations as if they had been performed on unencrypted biometric templates. Accordingly, encrypted results may be passed between devices and or software applications and a receiving device may decrypt the encrypted result and use the encrypted and/or decrypted result for match verification purposes. Embodiments of the invention may make use of any suitable homomorphic cryptosystem including partially homomorphic cryptosystems such as, but not limited to, unpadded RSA, ElGamal, Paillier, etc., as well as fully homomorphic cryptosystems such as, but not limited to, Gentry's cryptosystem, Brakerski's scale-invariant cryptosystem, Fan-Vercauteren cryptosystem (FV), etc. The use of homomorphic encryption in face matching is described in V. Naresh Boddeti, “Secure Face Matching Using Fully Homomorphic Encryption,” 2018 IEEE 9th International Conference on Biometrics Theory, Applications and Systems (BTAS), Redondo Beach, CA, USA, 2018, pp. 1-10, doi: 10.1109/BTAS.2018.8698601 which is incorporated by reference in its entirety.

A “threshold” can be a minimum prescribed level and/or value. For example, a threshold can identify or quantify what degree of similarity is needed between two biometric templates (or other data) for the two biometric templates to qualify as a match. As an illustration, fingerprints contain a certain number of identifying features. If a threshold (e.g., 90%) amount of identifying features of a newly measured fingerprint are matched to a similar amount of identifying features of a previously measured fingerprint, then the two fingerprints can be considered a match (and the probability that both fingerprints are from the same person may be high).

The term “public/private key pair” may include a pair of linked cryptographic keys generated by an entity (e.g., a computing device or an electronic device). The public key may be used for public functions such as encrypting a message to send to the entity or for verifying a digital signature which was supposedly made by the entity. The private key, on the other hand may be used for private functions such as decrypting a received message or applying a digital signature. The public key will usually be authorized by a body known as a Certification Authority (CA) which stores the public key in a database and distributes it to any other entity which requests it. The private key will typically be kept in a secure storage medium and will usually only be known to the entity. Public and private keys may be in any suitable format, including those based on elliptic curve cryptography (ECC), lattice or code based cryptosystems such as McEliece or learning with errors (LWE) which may be post-quantum secure.

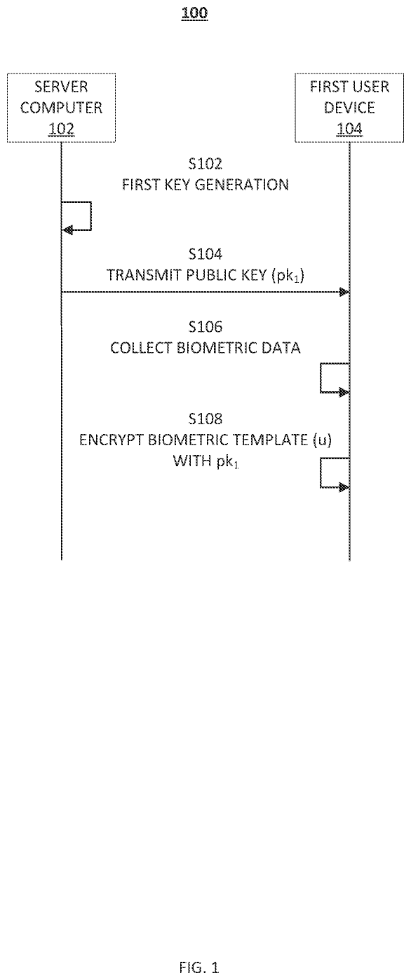

FIGS. 1, 2, and 3 include communication flows between a server computer 102, a first user device 104, and/or a second user device 106. They can communicate may include any suitable communication medium. The communication medium may comprise a communication network and may be one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Message between the entities, providers, networks, and devices illustrated in FIGS. 1, 2, and 3 may be transmitted using a secure communications protocols such as, but not limited to, File Transfer Protocol (FTP), HyperText Transfer Protocol (HTTP), Secure Hypertext Transfer Protocol (HTTPS), Secure Socket Layer (SSL), Transportation Layer Security (TLS), and the like.

In some embodiments, the server computer 102 can be remotely located with the respect to the first user device 104 and the second user device 106, while the first user device 104 and the second user device 105 can be proximate to each other or remotely located with respect to each other. In other embodiments, the server computer 102 could be a cloud computer. In other embodiments, the server computer 102 could be a secure element or other type of trusted execution environment in either the first user device 104 or the second user device 106.

FIG. 1 shows a swim-lane diagram of enrolling a biometric template (u) of a user with a first user device 104. In order to preserve privacy, the biometric template can be encrypted and enrolled with the first user device 104 such that a server computer 102 does not obtain the user's plaintext biometric template. During the enrollment, the server computer 102 can be remotely located with respect to the first user device 104.

In step S102, the server computer 102 can perform a cryptographic protocol to generate a first public-private key pair (pk₁, sk₁) comprising a first public key (pk₁) and a first private key (sk₁).

In step S104, the server computer 102 can transmit the first public key (pk₁) to the first user device 104. Upon receiving the public key (pk₁), the first user device 104, can store the first public key (pk₁) in its data storage.

In step S106, the first user device 104 can collect first biometric data of the user. The first biometric data may be the user's fingerprint, face image, voice print, etc. For example, the first user device 104 may collect the user's facial image by using a camera of the first user device 104. The first user device 104 can additionally use different active liveness detection techniques to identify that the user providing the first biometric data is live and not fake. For example, the first user device can use a facial active liveness detection technique to detect that the user providing a facial image (an example of first biometric data) that is not a picture but a live person. The first biometric data can then be processed by the first user device 104 to generate the biometric template (u).

In step S108, the first user device 104 can encrypt the biometric template (u) in step S106 using the first public key (pk₁). A homomorphic encryption process may be used to encrypt the biometric template (u) using the first public key (pk₁). Once the biometric template ([u]) is encrypted, the first user device can store the encrypted biometric template ([u]) in its data base.

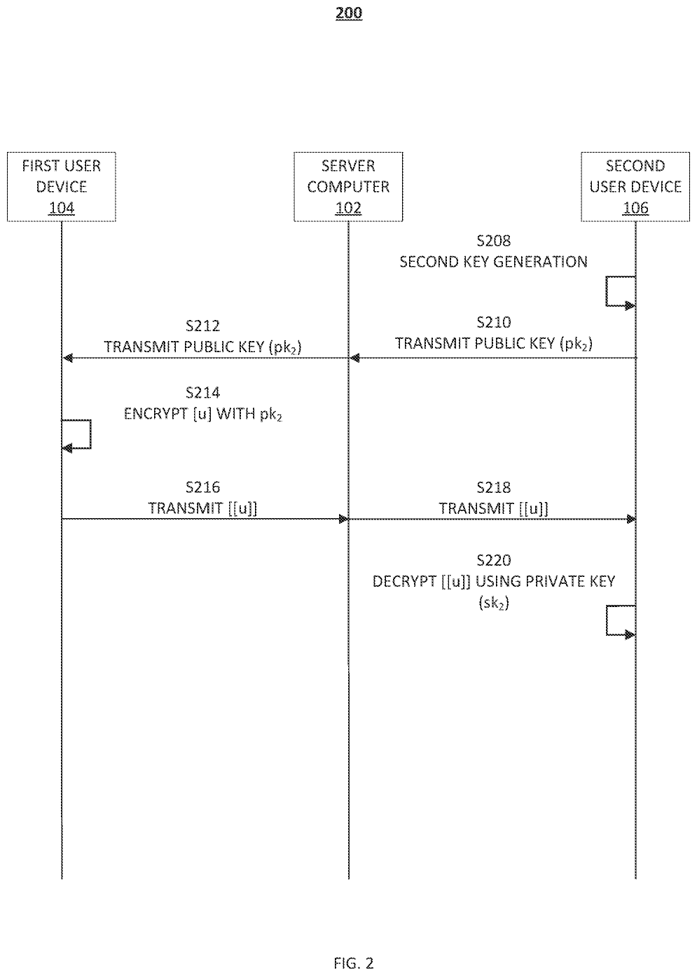

FIG. 2 shows a swim lane diagram of a first user device 104 sharing an encrypted biometric template ([u]) with a second user device 106. The first user device 104 may store the encrypted biometric template ([u]) obtained from the enrollment process described with respect to FIG. 1. An encrypted biometric template ([u]) of the first user device 104 may be shared with a second user device 106 such that the user does not have to re-enroll a new biometric template with the second user device 106 (as in the process described above with respect to FIG. 1.

The situation depicted in FIG. 2 can be useful when a user is operating the first user device 104, but then obtains the second user device 106. For example, the first user device 104 may be a mobile phone of the user, and the second user device 106 may be a wearable device that the user has obtained (e.g., through a personal purchase or assigned via the user's workplace). In another example, the first user device 104 can be a current mobile phone of a user, and the second user device 106 may be a new mobile phone obtained by the user.

During the process transmitting the encrypted biometric template ([u]) from the first user device 104 to the second user device 106, the server computer 102 can be remotely located with respect to the first user device 104 and the second user device 106 while the first user device 104 and the second user device 106 may be in a close proximity to each other. For example, the user may have both an old mobile phone (e.g., first user device) and a new mobile phone (e.g., second user device) in its possession when sharing the encrypted biometric template ([u]) from the old mobile phone to the new mobile phone.

In step S208, the second user device 106 can perform a cryptographic protocol to generate a second public-private key pair (pk₂, sk₂) comprising a second public key (pk₂) and a second private key (sk₂).

In step S210, the second user device 106 can transmit the second public key (pk₂) to the server computer 102 while storing the second private key (sk₂). The second user device 106 can optionally send a first digital certificate that can authenticate the identity of the second user device 106 to prove that the second user device 106 owns the second public key (pk₂). The first digital certificate may contain the certificate owner's name (i.e., second user device), the second public key (pk₂) and its expiration date, certificate issuer's name, certificate issuer's digital signature, etc. In some embodiments, the second user device 106 may transmit the second public key (pk₂) and optionally the first digital certificate to the first user device 104 directly, without transmitting it through the server computer 102.

In step S212, upon receiving the second public key (pk₂) and the optional first digital certificate, the server computer 102 can review the first digital certificate to determine if it trusts the second user device 106. If it does, then a trusted communication session can be formed between the second user device 106 and the server computer 102. Other ways of forming trusted communication channels (such as with session keys formed using shared secrets) can be used in other embodiments of the invention. The server computer 102 can then transmit the second public key (pk₂) and optionally the first digital certificate to the first user device 104.

In step S214, upon receiving the second public key (pk₂) and the first digital certificate, the first user device 104 can review the content in the first digital certificate and form a trusted communication session between the second user device 106 and the first user device 104. The first user device 104 can then encrypt the encrypted biometric template ([u]) using the second public key (pk₂) to form a double encrypted biometric template ([[u]]). The encrypted biometric template ([u]) can be the biometric template (u) encrypted using the first public key (pk₁) of the first public-private key pair in FIG. 1.

In step S216, the first user device 104 can then send the double encrypted biometric template ([[u]]) and the first public key (pk₁) to the server computer 102. In some embodiments, the first user device 104 may transmit the double encrypted biometric template ([[u]]) and the first public key (pk₁) directly to the second user device 106 directly without transmitting them through the server computer 102.

In step S218, upon receiving the double encrypted biometric template ([[u]]) and the first public key (pk₁), the server computer 102 can transfer the double encrypted biometric template ([[u]]) and the first public key (pk₁) to the second user device 106. In some embodiments, the server computer 102 can store the double encrypted biometric template ([[u]]) in its database, before transmitting it to the second user device 106.

In step S220, upon receiving the double encrypted biometric template ([[u]]) and the first public key (pk₁), the second user device 106 can decrypt the double encrypted biometric template ([[u]]) using the second private key (sk₂) to obtain the encrypted biometric template ([u]). The second user device 106 can then store the encrypted biometric template ([u]) in its database (or other data storage) and need not perform the process of enrolling the biometric template (u) with the server computer 102 as described above with respect to FIG. 1.

In some embodiments, the protocol of transferring the encrypted biometric template ([u]) in FIG. 2 may be performed in advance. For example, steps S208 to S216 can be performed in advance, such that the first user device 104 may not need to be online at the time of the sharing the encrypted biometric template. The double encrypted biometric template ([[u]]) may be stored in the server computer 102 before the second user device 106 requests that it be enrolled.

Note that the process shown and described with respect to FIG. 2 can be repeated for any number of user devices.

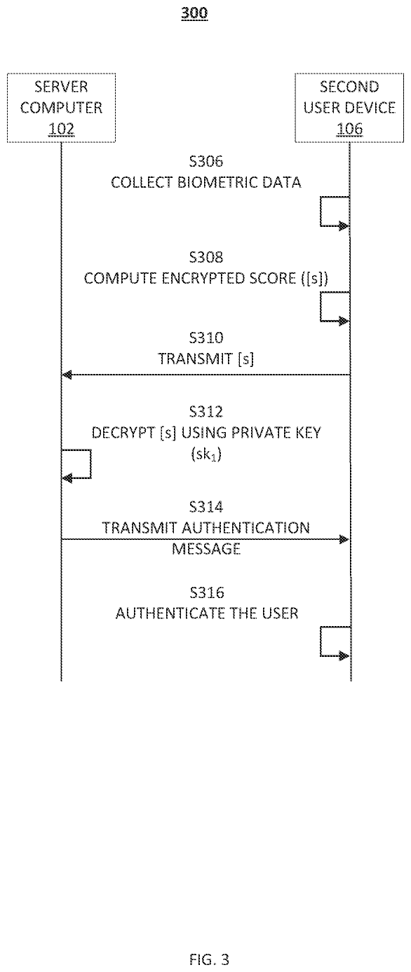

FIG. 3 shows a swim-lane diagram of a second user device 106 authenticating a test biometric template (v) to perform a process (e.g., access secure data or an application). The second user device 106 can use the encrypted biometric template ([u]) received from FIG. 2 and compare it to a test biometric template (v) to authenticate the user.

In step S306, the second user device 106 can collect second biometric data of the user. The second biometric data may be the user's fingerprint, face capture, etc. For example, the second user device 106 may collect the user's facial image by using a camera of the second user device 106. The second user device 106 can additionally use different active liveness detection techniques to detect that the user providing the second biometric data is live and is not fake. For example, the second user device 106 can use facial active liveness detection technique to detect that the user providing a facial image is not a picture, but is a real person. The second biometric data can then be processed by the second user device 106 to generate a test biometric template (v).

After processing the second biometric data into the test biometric template, the second user device 106 can encrypt the test biometric template (v) using the first public key (pk₁) received from the first user device 104. A homomorphic encryption process may be used to encrypt the biometric template (u) using the first public key (pk₁).

In step S308, the second user device 106 may generate an encrypted biometric match score ([s]) based on comparing the encrypted test biometric template ([v]) and the encrypted biometric template ([u]). Since both of the encrypted test biometric template ([v]) and the encrypted biometric template ([u]) are homomorphic encryptions, the encrypted biometric match score ([s]) may be an encryption of a biometric match score comparing the test biometric template (v) and the biometric template (u). The biometric match score may indicate the degree to which the biometric template and the test biometric template match. For example, a biometric match score of 80 may indicate a high match while a biometric match score of 10 may indicate a low match.

In step S310, upon obtaining the encrypted biometric match score ([s]) by the second user device 106, the second user device 106 can transmit the encrypted biometric match score ([s]) to the server computer 102.

In step S312, the server computer 102, upon receiving the encrypted match score ([s]), can decrypt the encrypted biometric match score ([s]) by using the first private key (sk₁) of the first public-private key pair to obtain the plaintext match score (s). The server computer 102 can then determine whether the biometric match score (s) is above a threshold. If the biometric match score is above the threshold, then the server computer can allow the second user device 106 to perform the process (e.g., access secure data or an application). For example, a threshold score may be 80, and if the biometric match score is 82 (or any score above 80), then the server computer 102 can allow the second user device 106 to perform a process (e.g., give the user the access to the second user device 106 or an application on the second user device 106).

In step S316, the server computer can transmit an authentication message indicating whether or not the biometric match score is above the threshold or not to the second user device 106.

In step S316, upon receiving the authentication message, the second user device can perform the process based on the authentication message. The process can include authenticating the user, giving the user access to secure data, accessing a location, performing a payment transaction, etc.

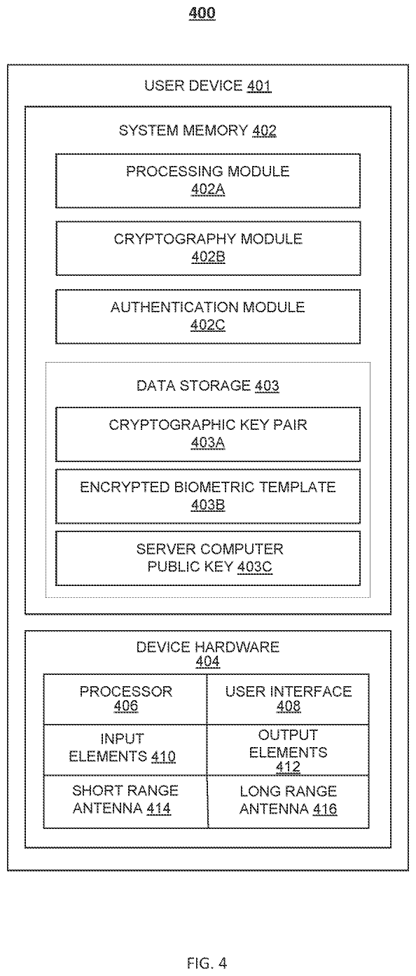

FIG. 4 illustrates a user device 400 according to an embodiment. User device 400 may include device hardware 404 coupled to a system memory 402. The user device 400 may be a mobile device, tablet, laptop, or any electronic devices that has the features of device hardware 404 along with the system memory 402.

Device hardware 404 may include a processor 406, an antenna 416, input elements 410, a user interface 408, and output elements 412 (which may be part of the user interface 408). Input elements can comprise a biometric reader which can be used to read biometric data of a user. Examples of input elements may include microphones, keypads, touchscreens, sensors, camera, etc. Examples of output elements may include speakers, display screens, and tactile devices.

The antenna 416 may include one or more RF transceivers and/or connectors that can be used by user device 400 to communicate with other devices and/or to connect with external networks such as a remote cellular or data network. It may also be configured to communicate with external entities through a short range communication medium (e.g., using Bluetooth, Wi-Fi, infrared, NFC, etc.). For example, a second user device can transmit a second public key (pk₂) directly to a first user device using the short range communication medium. The user interface 408 can include any combination of input and output elements to allow a user to interact with and invoke the functionalities of user device 400.

The system memory 402 can be implemented using any combination of any number of non-volatile memories (e.g., flash memory) and volatile memories (e.g., DRAM, SRAM), or any other non-transitory storage medium, or a combination thereof. The system memory 402 may store computer code, executable by the processor 406, for performing any of the functions described herein. For example, the memory 402 may store code, executable by the processor 406 to perform a method comprising: generating, by a second user device, a second public key and a second private key of a second public-private key pair; transmitting, by the second user device, the second public key to a first user device, which stores an encrypted biometric template, the encrypted biometric template being a biometric template encrypted with a first public key of a first public-private key pair, wherein the first user device encrypts the encrypted biometric template with the second public key to form a double encrypted biometric template; receiving, by the second user device, the double encrypted biometric template from the first user device; decrypting, by the second user device, the double encrypted biometric template using the second private key to obtain the encrypted biometric template; determining, the second user device, a test biometric template and encrypting the test biometric template; comparing, by the second user device, the encrypted test biometric template and the encrypted biometric template to obtain an encrypted biometric match score; and transmitting, by the second user device, the encrypted biometric match score to a server computer, wherein the server computer decrypts the encrypted biometric match score to obtain a biometric match score, and allowing the second user device to perform a process if the biometric match score exceed a threshold.

The system memory 402 may also store a processing module 402A, a cryptography module 402B, an authentication module 402C. The processing module 402A may include instructions or code, executable by the processor 406, to process a biometric data into a biometric template. For example, a first user device can process a first biometric data into a biometric template. The cryptography module 402B may comprise code, executable by the processor 406, to perform any of the above-described cryptographic procedures operations including generating a public-private key pair, performing an encryption/decryption scheme, performing a homomorphic comparison, etc. The authentication module 402C may comprise code, executable by the processor 406, to allow the user device to perform a process (e.g., access secure data or an application) upon receiving an authentication message indicating that a biometric match score exceeds a threshold score.

System memory 402 may also have a data storage 403 comprising a cryptographic key pair 403A, an encrypted biometric template 403B, and a server's public key 403C. The cryptographic key pair 403A such as a public-private key pair can be generated by the user device 401 using the cryptography module 402B and can be used to encrypt plaintext and decrypt ciphertext. The encrypted biometric template 403B can be an encryption of a biometric template. The biometric template may be biometric data processed by the user device 401 using the processing module 402A. The server computer public key 403C can be a first public key of a server computer received to encrypt the biometric template.

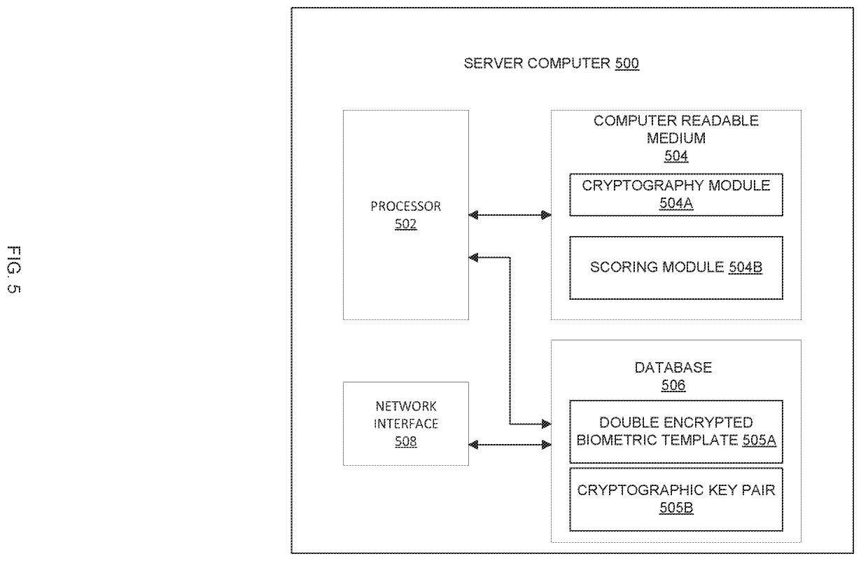

FIG. 5 shows a server computer 500. The server computer 500 includes a processor 502, a computer readable medium 504, a database 506, and a network interface 508 coupled to the processor 502.

The computer readable medium 504 may comprise a cryptography module 504A and a scoring module 504B. The cryptography module 504A may comprise code, executable by the processor 502, to perform any of the above described cryptographic operations such as generating a cryptographic key pair 505B, performing encryption and decryption, performing signing and verification, etc. For example, the server computer 500 can use the cryptography module 504A to generate a first public-private key pair (i.e., cryptographic key pair). In another example, the server computer can use the cryptography module 504A to decrypt an encrypted score received from a second user device. The scoring module 504B may comprise code, executable by the processor 502, to determine whether a score exceeds a threshold value to allow a second user device to perform a process if the score exceeds the threshold value.

The computer readable medium 504 may comprise code executable by the processor 502 to perform operations including: generating a first public-private key pair comprising a first public key and a first private key; transmitting the first public key to a first user device, which encrypts a biometric template with the first public key to form an encrypted biometric template, encrypts the encrypted biometric template with a second public key of a second public-private key pair to form a double encrypted biometric template, and transfers the double encrypted biometric template to a second user device, which decrypts the double encrypted biometric template with a second private key of the second public-private key pair to obtain the encrypted biometric template, receives a test biometric template, encrypts the test biometric template using the first public key, and computes an encrypted score using the encrypted biometric template and the encrypted test biometric template; receiving the encrypted score; decrypting, by the server computer the encrypted score using the first private key to form a biometric match score; determining, by the server computer, if the biometric match score exceeds a threshold; and performing a process on behalf of the second user device if the score exceeds the threshold.

The database 506 may store a double encrypted biometric template 505A and the cryptographic key pair 505B. The double encrypted biometric template 505A may be received from a first user device as determined above with respect to FIG. 3 and may be stored in the database 506 such that the first user device can be offline when at the time of sharing the encrypted biometric template to the second user device. The cryptographic key pair 505B may be a public-private key pair that can be generated by the server computer 500 using the cryptography module 402B and can be used to encrypt plaintext and decrypt ciphertext.

Embodiments can have several advantages. One advantage is that during the process of authentication, the server computer coordinating the transmission of encrypted biometric templates and performing verification is not able to learn the plaintext biometric data or biometric templates of the user. Another advantage is that a second user device can be loaded with an encrypted biometric template from a different first user device in a secure manner, without requiring a user to enroll a biometric template with the second user device. The biometric templates are encrypted when then are transferred between the first user device and the second user device, and the server computer, thereby protecting the user's data.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
generating, by a second user device, a second public key and a second private key of a second public-private key pair;
transmitting, by the second user device, the second public key to a first user device, which stores an encrypted biometric template, the encrypted biometric template being a biometric template encrypted with a first public key of a first public-private key pair, wherein the first user device encrypts the encrypted biometric template with the second public key to form a double encrypted biometric template;
receiving, by the second user device, the double encrypted biometric template from the first user device;
decrypting, by the second user device, the double encrypted biometric template using the second private key to obtain the encrypted biometric template;
determining, by the second user device, a test biometric template and encrypting the test biometric template;
comparing, by the second user device, the encrypted test biometric template and the encrypted biometric template to obtain an encrypted biometric match score; and
transmitting, by the second user device, the encrypted biometric match score to a server computer, wherein the server computer decrypts the encrypted biometric match score to obtain a biometric match score, and allowing the second user device to perform a process if the biometric match score exceed a threshold.

2. The method of claim 1, wherein the encrypted biometric template is encrypted by the first user device using a homomorphic encryption scheme.

3. The method of claim 1, wherein the second public key is transmitted to the first user device via the server computer.

4. The method of claim 1, wherein the test biometric template is encrypted with the first public key of a first public-private key-pair.

5. The method of claim 1, wherein the test biometric template is derived from a facial scan, a fingerprint scan, a palm print, an iris scan, or a voice print.

6. The method of claim 1, wherein the server computer decrypts the encrypted biometric match score using a first private key of the first public-private key pair.

7. The method of claim 1, wherein the first user device is a mobile phone of a user and the second user device is a wearable device of the user.

8. The method of claim 1, wherein the first user device is a current mobile phone of a user and the second user device is a new mobile phone of the user.

9. The method of claim 1, wherein the server computer generates the first public-private key pair, and wherein the double encrypted biometric template is received by the second user device via the server computer, and the server computer stores the double encrypted biometric template.

10. The method of claim 1, wherein the server computer generates the first public-private key pair, and wherein the method further comprises:
receiving, by the first user device, the first public key from the server computer;
collecting, by the first user device, the biometric template; and
encrypting, by the first user device, the biometric template with the first public key to form the encrypted biometric template.

11. The method of claim 1, wherein the server computer is remotely located with respect to the first user device and the second user device.

12. The method of claim 1, wherein the server computer is remotely located with respect to the first user device and the second user device, and the first user device and the second user device are proximate to each other.

13. The method of claim 1, wherein the second user device transmits the second public key directly to the first user device using a short range communication medium.

14. The method of claim 1, wherein the second public key is transmitted to the first user device, and the double encrypted biometric template is received by the second user device from the first user device during a trusted communication session.

15. A second user device comprising:
a processor;
a memory comprising a hash index table and an array index table; and
a computer readable medium coupled to the process, the computer readable medium comprising code executable by the processor for performing operations comprising:
generating a second public key and a second private key of a second public-private key pair;
transmitting the second public key to a first user device, which stores an encrypted biometric template, the encrypted biometric template being a biometric template encrypted with a first public key of a first public-private key pair, wherein the first user device encrypts the encrypted biometric template with the second public key to form a double encrypted biometric template;
receiving the double encrypted biometric template;
decrypting the double encrypted biometric template using the second private key to obtain the encrypted biometric template;
determining a test biometric template and encrypting the test biometric template;
comparing the encrypted test biometric template and the encrypted biometric template to obtain an encrypted match score; and
transmitting the encrypted biometric match score to a server computer, wherein the server computer decrypts the encrypted biometric match score to obtain a biometric match score, and allowing the second user device to perform a process if the biometric match score exceed a threshold.

16. The second user device of claim 15, wherein the encrypted biometric template is encrypted by the first user device using a homomorphic encryption scheme.

17. The second user device of claim 15, wherein the second public key is transmitted to the first user device via the server computer.

18. The second user device of claim 15, wherein the test biometric template is encrypted with the first public key of a first public-private key-pair.

19. A method comprising:
generating, by a server computer, a first public-private key pair comprising a first public key and a first private key;
transmitting, by the server computer, the first public key to a first user device, which encrypts a biometric template with the first public key to form an encrypted biometric template, encrypts the encrypted biometric template with a second public key of a second public-private key pair to form a double encrypted biometric template, and transfers the double encrypted biometric template to a second user device, which decrypts the double encrypted biometric template with a second private key of the second public-private key pair to obtain the encrypted biometric template, receives a test biometric template, encrypts the test biometric template using the first public key, and computes an encrypted score using the encrypted biometric template and the encrypted test biometric template;
receiving, by the server computer, the encrypted score;
decrypting, by the server computer the encrypted score using the first private key to form a biometric match score;
determining, by the server computer, if the biometric match score exceeds a threshold; and
performing a process on behalf of the second user device if the score exceeds the threshold.

20. The method of claim 19, wherein the double encrypted biometric template passes through the server computer before the double encrypted biometric template is received by the second user device, and wherein the method further comprises:
storing, by the server computer, the double encrypted biometric template.
